(19) United States
(12) Patent Application Publication
(10) Pub. No.: US 2008/0232688 A1
(43) Pub. Date: Sep. 25, 2008

(54) EVENT DETECTION IN VISUAL SURVEILLANCE SYSTEMS

(76) Inventors: Andrew W. Senior, New York, NY (US); Ying-Ii Tian, Yorktown Heights, NY (US)

Correspondence Address: HOFFMAN WARNICK LLC, 75 STATE ST, 14TH FLOOR, ALBANY, NY, 12207, US

(21) Appl. No.: 12/016,454

(22) Filed: Jan. 18, 2008

Related U.S. Application Data
(60) Provisional application No. 60/895,867, filed on Mar. 20, 2007.

(51) Int. Cl. G06K 9/00

(52) U.S. Cl. 382/181

(57) ABSTRACT

An improved solution for detecting events in video is provided, in which a region of interest within a series of video images of the video is monitored. An object at least partially visible within the series of video images is tracked and a fiducial region of the object is identified. The fiducial region is one or more points and/or area(s) of the object, which are relevant in determining whether an alert should be generated. The fiducial region is monitored with respect to the region of interest and a restricted behavior. When the restricted behavior is detected with respect to the region of interest, an alert is generated.

### REFERENCE TO PRIOR APPLICATIONS

The current application claims the benefit of co-pending U.S. Provisional Application No. 60/895,867, titled “Alert detection in visual surveillance systems”, which was filed on 20 Mar. 2007, and which is hereby incorporated by reference.

### TECHNICAL FIELD OF THE INVENTION

Aspects of the present invention relate to the field of video camera systems. More particularly, an embodiment of the present invention relates to the field of automatically detecting events in video.

### BACKGROUND OF THE INVENTION

In typical surveillance video, the frequency of occurrences of notable events is relatively low. Either there is no change in the scene observed by the camera, or the changes are routine and not of interest. Because of this, it is very difficult for a person to maintain attention when observing video. Automatic video surveillance systems attempt to overcome this problem by using computer processing to analyze the video and determine what activity is taking place. Human attention can then be drawn to the (far fewer and more interesting) events that the machine has detected. One method of drawing attention to particular events is to set up an alert for a specific type of behavior.

Many systems have the capability for delivering to a user an alert when an event, pre-selected by a user, has occurred. Such systems can detect motion alerts, that is, send an alert whenever any motion happens in the field of view of the camera. Usually this is refined by specifying a region of interest where the motion must happen to trigger the alert. More complex systems may allow the user to define criteria for the duration or area of the motion, or even its direction.

A motion detection alert may detect motion in an area of a video image simply by comparing one frame to the next and counting how many pixels change in a region. A more sophisticated method may build a background model and after various operations to “clean” the answer, count the number of changed pixels within the region. An alternative method would be for a tracker to track the moving object(s) and determine if the tracked object(s) entered the region.

### SUMMARY OF THE INVENTION

Aspects of the present invention are directed to a solution for detecting events in video, for example, video from a surveillance camera. The solution allows a user to pre-specify events that the user is interested in and will notify the user when those events occur. Such systems exist, and detect events, called “alerts” or “alarms” of types including the following: motion detection, movement across tripwire, movement in a specified direction, etc. Aspects of the solution provide an alternative method of defining and detecting a video event, with greater flexibility and thus discriminative power. In particular, a region of interest within a series of video images of the video is monitored. An object at least partially visible within the series of video images is tracked and a fiducial region of the object is identified. The fiducial region is one or more points and/or area(s) of the object, which are relevant in determining whether an alert should be generated. The fiducial region is monitored with respect to the region of interest and a restricted behavior. When the restricted behavior is detected with respect to the region of interest, an alert is generated.

A first aspect of the invention provides a method for detecting events in video comprising: monitoring a region of interest within a series of video images of the video; tracking an object within the video, the tracking including identifying a fiducial region of the object within the series of video images, the fiducial region being one of: a point, a group of points, or a portion of an entire area of the object; monitoring the fiducial region for a restricted behavior with respect to the region of interest; and generating an alert in response to detecting the restricted behavior with respect to the region of interest.

A second aspect of the invention provides a system for detecting events in video comprising: a component for monitoring a region of interest within a series of video images of the video; a component for tracking an object within the video, the tracking including identifying a fiducial region of the object within the series of video images, the fiducial region being one of: a point, a group of points, or a portion of an entire area of the object; a component for monitoring the fiducial region for a restricted behavior with respect to the region of interest; and a component for generating an alert in response to detecting the restricted behavior with respect to the region of interest.

A third aspect of the invention provides a computer program comprising program code stored on a computer-readable medium, which when executed, enables a computer system to implement a method of detecting events in video, the method comprising: monitoring a region of interest within a series of video images of the video; tracking an object within the video, the tracking including identifying a fiducial region of the object within the series of video images, the fiducial region being one of: a point, a group of points, or a portion of an entire area of the object; monitoring the fiducial region for a restricted behavior with respect to the region of interest; and generating an alert in response to detecting the restricted behavior with respect to the region of interest.

A fourth aspect of the invention provides a method of generating a system for detecting events in video, the method comprising: providing a computer system operable to: monitor a region of interest within a series of video images of the video; track an object within the video, the tracking including identifying a fiducial region of the object within the series of video images, the fiducial region being one of: a point, a group of points, or a portion of an entire area of the object; monitor the fiducial region for a restricted behavior with respect to the region of interest; and generate an alert in response to detecting the restricted behavior with respect to the region of interest.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative environment for detecting events in video according to an embodiment.

FIG. 2 shows an illustrative process flow for activating an alert according to an embodiment.

FIGS. 3A-C show illustrative user interfaces according to an embodiment.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

This disclosure discusses a solution for detecting alerts/events in an automatic visual surveillance system. An example of this type of surveillance system is known as the “Smart Surveillance System” and is described in A. Hampapur, L. Brown, J. Connell, S. Pankanti, A. W. Senior, and Y.-L. Tian, Smart Surveillance: Applications, Technologies and Implications, IEEE Pacific-Rim Conference on Multimedia, Singapore, December 2003, which is incorporated herein by reference.

As indicated above, aspects of the invention provide a solution in which a region of interest within a series of video images is monitored. An object at least partially visible within the series of video images is tracked and a fiducial region of the object is identified. The fiducial region is one or more points and/or area(s) of the object, which are relevant in determining whether an alert should be generated. The fiducial region is monitored with respect to the region of interest and a restricted behavior. When the restricted behavior is detected with respect to the region of interest, an alert is generated. As used herein, unless otherwise noted, the term “set” means one or more (i.e., at least one) and the phrase “any solution” means any now known or later developed solution.

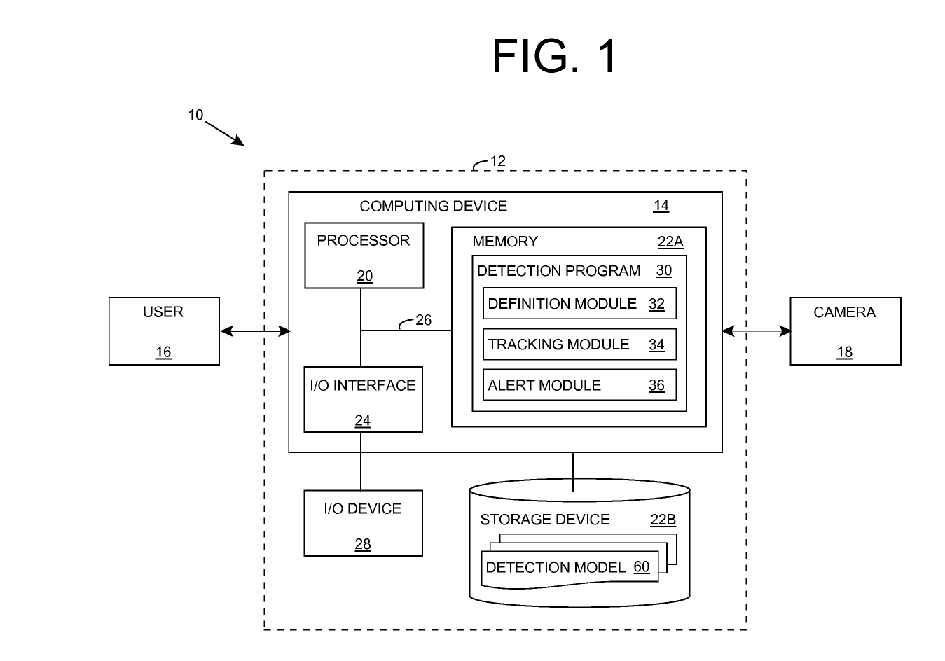

Turning to the drawings, FIG. 1 shows an illustrative environment 10 for detecting events in video according to an embodiment. In particular, environment 10 can generate an alert in an automatic visual surveillance system. To this extent, environment 10 includes a computer system 12 that can perform the process described herein in order to detect events in video captured by camera 18. In particular, computer system 12 is shown including a computing device 14 that comprises a detection program 30, which makes computing device 14 operable to detect events in the video by performing the process described herein. As used herein, the term “video” means any series of still images captured by camera 18. To this extent, camera 18 can comprise a still camera or a video camera, which periodically captures still images (also referred to as “video images”) using any intervening time frame.

Computing device 14 is shown including a processor 20, a memory 22A, an input/output (I/O) interface 24, and a bus 26. Further, computing device 14 is shown in communication with an external I/O device/resource 28 and a storage device 22B. In general, processor 20 executes program code, such as detection program 30, which is stored in a storage system, such as memory 22A and/or storage device 22B. While executing program code, processor 20 can read and/or write data, such as detection model 60, to/from memory 22A, storage device 22B, and/or I/O interface 24. Bus 26 provides a communications link between each of the components in computing device 14. I/O device 28 can comprise any device that transfers information between a user 16 and computing device 14. To this extent, I/O device 28 can comprise a human-usable I/O device to enable an individual (user 16) to interact with computing device 14 and/or a communications device to enable a system (user 16) to communicate with computing device 14 using any type of communications link.

In any event, computing device 14 can comprise any general purpose computing article of manufacture capable of executing program code installed thereon. However, it is understood that computing device 14 and detection program 30 are only representative of various possible equivalent computing devices that may perform the process described herein. To this extent, in other embodiments, the functionality provided by computing device 14 and detection program 30 can be implemented by a computing article of manufacture that includes any combination of general and/or specific purpose hardware and/or program code. In each embodiment, the program code and hardware can be created using standard programming and engineering techniques, respectively.

Similarly, computer system 12 is only illustrative of various types of computer systems for implementing aspects of the invention. For example, in one embodiment, computer system 12 comprises two or more computing devices that communicate over any type of communications link, such as a network, a shared memory, or the like, to perform the process described herein. Further, while performing the process described herein, one or more computing devices in computer system 12 can communicate with one or more other computing devices external to computer system 12 using any type of communications link. In either case, the communications link can comprise any combination of various types of wired and/or wireless links; comprise any combination of one or more types of networks; and/or utilize any combination of various types of transmission techniques and protocols.

As shown in FIG. 1, memory 22A contains detection program 30 for detecting events in video according to an embodiment. Detection program 30 comprises a definition module 32 for defining a detection model 60, which includes a region of interest within a series of video images; a tracking module 34 for tracking a behavior of a fiducial region on an object in the series of video images, wherein the fiducial region corresponds to a point or a set of points on the object (e.g., pixels in the video image); and an alert module 36 for generating an alert when restricted behavior of the fiducial region with respect to the region of interest is detected.

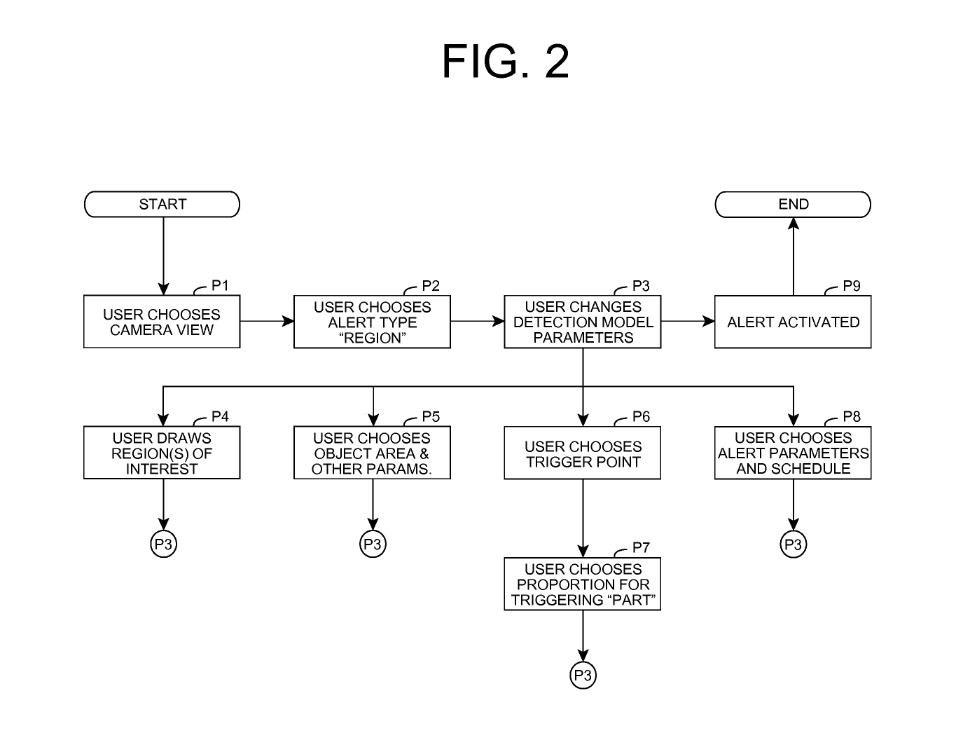

FIG. 2 shows an illustrative process flow for activating an alert according to an embodiment, which can be implemented by computer system 12, e.g., by executing and utilizing definition module 32. The alert is defined and stored as a detection model 60. Computer system 12 can manage the data in detection model 60 using any solution for storing data, rendering data, and manipulating data. Referring to FIGS. 1 and 2, in process P1, user 16 can use computer system 12 to choose a view for camera 18. To this extent, camera 18 can comprise a pan-tilt-zoom camera or the like, and user 16 can use computer system 12 to move camera 18. Further, user 16 can use computer system 12 to identify a particular field of view that includes some or all of a region of interest using any solution, e.g., by moving camera 18 so that it is imaging the field of view. In this case, computer system 12 can store the location of camera 18 in detection model 60.

In any event, in process P2, user 16 can use computer system 12 to choose an alert type “region”. Any type of region can be defined for an alert. For example, the region can comprise a two- or three-dimensional region within the video image(s) captured by camera 18. To this extent, the region could comprise an area on which people, vehicles, or other objects are placed (e.g., ground, floor, counter, and/or the like), or could comprise an area some height above the ground/floor. Further, the region could comprise a linear trigger or “tripwire” that extends across a portion of the video image (e.g., across an entry to a parking lot, a path, a doorway, and/or the like).

In process P3, user 16 can use computer system 12 to define and/or change various parameters of a detection model 60 using any solution. To this extent, computer system 12 can generate a summary user interface for the detection model 60, which includes the current definitions for the various region of interest, object, and/or alert parameters as defined in detection model 60 and enables user 16 to define and/or change one or more of the parameters. Initially, computer system 12 can populate some or all of the parameters with a set of default entries based on the alert type region. For example, computer system 12 could perform image processing on the video image to identify a likely location for a linear trigger.

For example, in process P4, user 16 can use computer system 12 to define a region of interest within a video image using any solution. For example, computer system 12 can generate a user interface that displays a video image that was captured by camera 18 when it had the field of view chosen by user 16. The user interface can include various user controls that enable user 16 to define the region of interest within the video image, e.g., by drawing a bounding polygon, a line (for a linear trigger), and/or the like. Computer system 12 can store the region of interest in detection model 60 using any solution. For example, computer system 12 can translate the region of interest into a two- or three-dimensional plane and perform transformation operations on the region of interest for different fields of view of camera 18 and/or the field(s) of view for one or more other cameras. If no region is specified, then the region may default to the entire video image or some pre-specified default. Additionally, the region may include multiple distinct regions of the image, e.g., as specified by two or more polygons.

In process P5, user 16 can use computer system 12 to choose an object area and other parameters for the object, which computer system 12 can store in detection model 60. To this extent, user 16 can identify one or more types of objects to be tracked (e.g., people, vehicles, and/or the like). Further, computer system 12 can enable user 16 to select a type of model to use for the object(s) being tracked. In particular, when an object is being tracked, it may be entirely visible within the field of view of camera 18 or only partially visible within the field of view. Further, computer system 12 can identify various attributes of the object. To this extent, computer system 12 (e.g., by executing tracking module 34) can generate and adjust a model of the object being tracked using any solution. The model can define an entire area within and/or without the field of view for the object. For example, when a person is being tracked and only the legs of the person are visible within the field of view, computer system 12 can generate a model that extends the area of the person to account for his/her upper torso.

In process P6, user 16 can use computer system 12 to specify a fiducial region (e.g., trigger point) for each type of object. As used herein, the fiducial region is a point, a group of points, or one or more areas of the object (e.g., a portion of the entire area of the object) that computer system 12 will monitor with respect to the alert defined in detection model 60 to determine if the triggering criterion(ia) is(are) met. The fiducial region can define an area (e.g., a head of an individual), multiple points/areas on an object (e.g., a point on each foot, or all the visible area of each foot), and/or the like. Additionally, when user 16 specifies a model for the object that includes a non-visible portion for the object, the fiducial region can be defined with respect to the model rather than with respect to only the visible portion of the object.

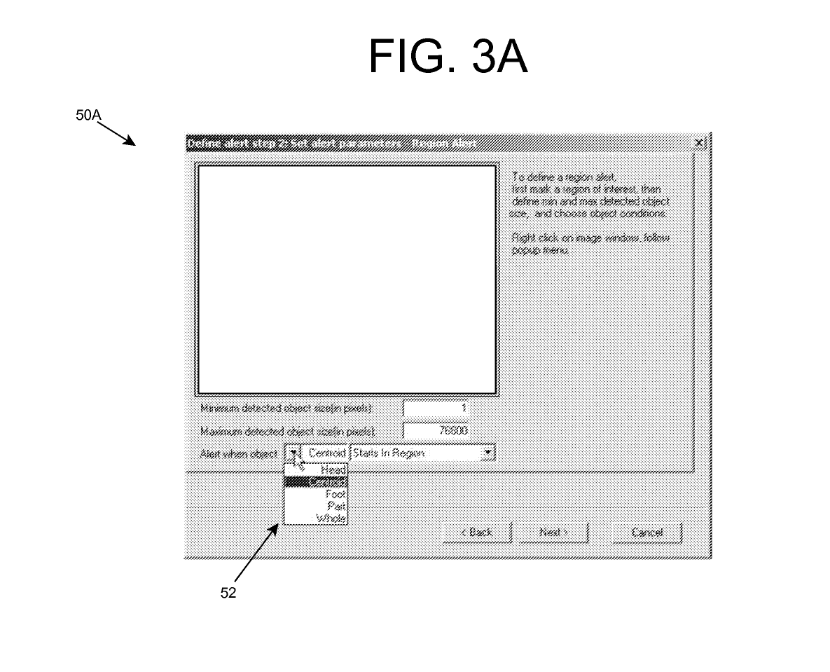

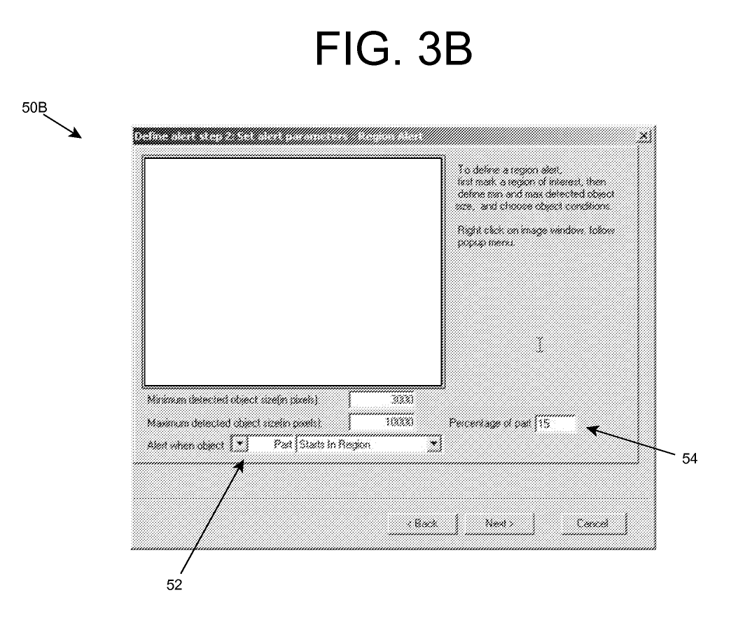

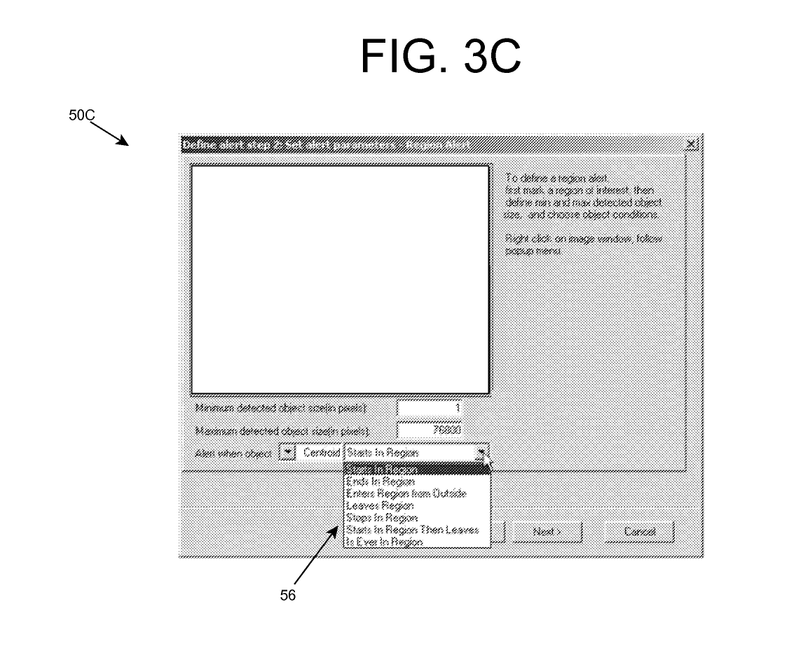

User 16 can specify the fiducial region using any solution. FIG. 3A shows an illustrative user interface 50A according to an embodiment, which enables user 16 to specify a fiducial region. In this illustrative embodiment, a variety of choices are presented to user 16 through a graphical user interface pull-down menu 52, which enables selection of the fiducial region for tracking a person. The illustrative options shown in menu 52 are “Centroid”, “Head”, “Foot”, “Part”, or “Whole”.

In this case, “Centroid” can be defined as the centroid of the object being tracked (e.g., the centroid of the model's weighted pixels based on the current model location). “Head” may be defined as the uppermost pixel in the object model, or a weighted average location of the uppermost pixels in the model, but can also have a more complex head and/or face detector determining a representative point location for the head based on the model, its history and the recent foreground regions associated with the object. Instead of a point, the head may be represented as a region or a set of pixels. Similarly, “Foot” may be the lowest pixel in the model, or some more complex determination of a representative point of the foot, or an area or set of pixels representing the foot and/or both feet.

In the case of these point measures, computer system 12 can consider the point as being inside the region of interest when it lies within the region, or within some margin of the region boundary (positive or negative). For an area or set of pixels, the stated part may be considered inside the region if all the pixels are within the region of interest, or if some specified proportion of the calculated area lies within the region of interest. In the case of “Whole”, the object can be determined to lie inside the region if all the model's pixels lie within the region of interest (ROI), and in the case of “Part”, if some proportion of the model pixels lie within the region. In the latter case, the proportion may be specified by user 16. To this extent, in process P7, user 16 can specify a proportion of the fiducial region, which is required to trigger the alert using any solution. For example, FIG. 3B shows an illustrative interface 50B, which includes a user interface control 54 that enables user 16 to specify the proportion as a percentage when “Part” is selected using control 52.

A number of variations on these basic options are possible. For instance, computer system 12 can enable user 16 to use other detectors or sub-part identification methods to determine other points of interest on a person, or other tracked object, according to the object and desired effect (e.g., hand, torso, nose, wheel, bumper, leftmost point, centroid of red area, etc.) using any solution. Similarly, computer system 12 can incorporate more sophisticated rules for determining that the selected part is within the region. Further, the various parameters for a detection model 60 may be specified by any combination of a number of approaches, including selecting options from pull-down menus, typing textual descriptions, and/or the like.

In any event, in process P8, computer system 12 can enable user 16 to specify other parameters for the alert, which are stored in detection model 60, using any solution. For example, as illustrated in FIG. 3C, an illustrative interface 50C can include a user interface control 56 that enables user 16 to specify a restricted behavior with respect to the region of interest. In this case, when computer system 12 can generate an alert in response to detecting that the fiducial region of an object being tracked has performed the restricted behavior. The restricted behavior can comprise any type of behavior that can be performed by the object/fiducial region of the object and detected by computer system 12. As illustrated in user interface control 56, illustrative behaviors include but are not limited to: “is ever in region”, which triggers the alert if computer system 12 determines that the fiducial region is in the region; “enters region from outside”; “leaves region”; “starts in region then leaves”; “ends in region”; “starts in region”; “stops in region”; and “starts outside region and enters”. In each case, computer system 12 must detect that the selected criterion is satisfied before triggering the alert.

One or more additional parameters can be specified with respect to the alert condition and/or region of interest such as: a (minimum) amount of time that the part must be in the region for the alert to be triggered; criteria for the area; a shape, class, color, speed and/or other attribute(s) of the object necessary to trigger the alert; and/or the like. For example, a velocity threshold (or other condition) can be used to determine when an object is “stopped” or moving too quickly (e.g., running, throwing a punch, and/or the like). Similarly other conditions may be specified such as ambient conditions (e.g. illumination level), or any other measurable attribute (e.g., weather, state of a door [open/closed], presence of other objects near by, etc.).

Detection model 60 can include any combination of various types of regions of interest (multi-dimensional and/or linear), restricted behaviors, and/or other parameters to form alert conditions that are based on more complex behaviors of the tracked object. For example, computer system 12 can enable user 16 to define a linear trigger using a line segment, curve, polyline, or the like, with the restricted behavior comprising “crosses the line” or “crosses the line from left to right”. Computer system 12 can enable user 16 to define more complex behavior with respect to the linear trigger, such as “crosses the line at an angle of incidence greater than 60 degrees”, “crosses the line and crosses back within T seconds”, and the like. Still further, a multi-dimensional region of interest can comprise one or more active edges, which can enable user 16 to define alerts such as “starts in the region and leaves across edge A”, “enters across edge A and leaves across edge B”, and the like.

More complex detection models 60 for alerts can be constructed from these basic mechanisms by combining them in a variety of ways, including Boolean operations (AND, OR, XOR, NOT, etc.), temporal relations (before, after, within t seconds of, etc.), identity requirements (same object, different object, any object, any blue object, etc.), and/or the like. For example, illustrative alerts can comprise: “Alert when (the head enters region A) and (the foot enters region B) within 3 seconds”, “Alert when an object leaves region C and any object is present in region D”, and the like.

Additionally, computer system 12 can enable user 16 to choose an alert schedule using any solution. For example, user 16 can specify days of a year, month, week, etc., on which alerts will be triggered (e.g., every New Years Day, Saturdays and Sundays, every day except the third Thursday of every month, or the like), time(s) of day (e.g., between 6:00 pm and 6:00 am), and/or the like.

Returning to FIGS. 1 and 2, when user 16 has completed defining the detection model 60 in processes P3-8, in process P9, computer system 12 can activate the alert. For example, alert module 36 can begin evaluating the locations and behaviors of various objects being tracked by tracking module 34 to determine whether one or more of the objects is performing a restricted behavior with respect to a region of interest for the alert and/or whether one or more additional parameters with respect to the region of interest are present (if required by the alert condition). If so, computer system 12 can generate the alert using any solution. For example, computer system 12 can generate an audio and/or visual alarm, which is presented to user 16. Further, computer system 12 can provide information on the alert, the type of the alert, highlight the object that caused the alert, and/or the like, for evaluation and potential action by user 16 using any solution.

Additionally, computing device 12 (e.g., by executing tracking module 34) can detect and address scene changes which may have been caused by unplanned or planned camera movement or camera blockage using any solution. For example, computing device 12 can use pan-tilt-zoom signals sent to camera 18 to determine the movement, compare fixed features of consecutive video images to identify any movement, compare a video image to a group of reference video images, and/or the like. In response to a change, computing device can adjust a location of the region(s) of interest within the field of view of camera 18 accordingly. Further, when the scene change is due to an obstruction, computing device 12 can suppress alert generation until the obstruction has passed to avoid false alerts, and/or generate an alert due to the obstruction (e.g., after T seconds have passed).

While shown and described herein as a method and system for generating an alert in response to an event in video, it is understood that the invention further provides various alternative embodiments. For example, in one embodiment, the invention provides a computer program stored on a computer-readable medium, which when executed, enables a computer system to detect events in video. To this extent, the computer-readable medium includes program code which implements the process described herein. It is understood that the term “computer-readable medium” comprises one or more of any type of tangible medium of expression capable of embodying a copy of the program code (e.g., a physical embodiment). In particular, the computer-readable medium can comprise program code embodied on one or more portable storage articles of manufacture, on one or more data storage portions of a computing device, such as memory 22A (FIG. 1) and/or storage system 22B (FIG. 1), as a data signal traveling over a network (e.g., during a wired/wireless electronic distribution of the computer program), on paper (e.g., capable of being scanned and converted to electronic data), and/or the like.

In another embodiment, the invention provides a method of generating a system for detecting events in video. In this case, a computer system, such as computer system 12 (FIG. 1), can be obtained (e.g., created, maintained, having made available to, etc.) and one or more programs/systems for performing the process described herein can be obtained (e.g., created, purchased, used, modified, etc.) and deployed to the computer system. To this extent, the deployment can comprise one or more of: (1) installing program code on a computing device, such as computing device 14 (FIG. 1), from a computer-readable medium; (2) adding one or more computing devices to the computer system; and (3) incorporating and/or modifying one or more existing devices of the computer system, to enable the computer system to perform the process described herein.

In still another embodiment, the invention provides a business method that performs the process described herein on a subscription, advertising, and/or fee basis. That is, a service provider, could offer to detect events in video, as described herein. In this case, the service provider can manage (e.g., create, maintain, support, etc.) a computer system, such as computer system 12 (FIG. 1), that performs the process described herein for one or more customers. In return, the service provider can receive payment from the customer(s) under a subscription and/or fee agreement, receive payment from the sale of advertising to one or more third parties, and/or the like.

As used herein, it is understood that “program code” means any set of statements or instructions, in any language, code or notation, that cause a computing device having an information processing capability to perform a particular function either directly or after any combination of the following: (a) conversion to another language, code or notation; (b) reproduction in a different material form; and/or (c) decompression. To this extent, program code can be embodied as any combination of one or more types of computer programs, such as an application/software program, component software/a library of functions, an operating system, a basic I/O system/driver for a particular computing, storage and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method for detecting events in video comprising:
monitoring a region of interest within a series of video images of the video;
tracking an object within the video, the tracking including identifying a fiducial region of the object within the series of video images, the fiducial region being one of: a point, a group of points, or a portion of an entire area of the object;
monitoring the fiducial region for a restricted behavior with respect to the region of interest, wherein at least one of the fiducial region or the restricted behavior is specified by a user; and
generating an alert in response to detecting the restricted behavior with respect to the region of interest.

2. The method of claim 1, wherein the fiducial region is one of: a centroid of a model for the object or a centroid of an area of the object visible within the video.

3. The method of claim 1, wherein the object is a person and wherein the fiducial region represents one of: a head, a hand, or a foot of the person.

4. The method of claim 1, wherein the region of interest comprises a linear trigger.

5. The method of claim 1, wherein the behavior is selected from the group consisting of: crossing the region of interest, entering the region of interest, leaving the region of interest, or being present within the region of interest.

6. The method of claim 1, wherein the restricted behavior comprises a plurality of conditions for the object in the region of interest.

7. The method of claim 1, further comprising monitoring at least one additional parameter with respect to the alert, wherein generating the alert requires detecting a specified condition of the at least one additional parameter.

8. A system for detecting events in video comprising:
a component for monitoring a region of interest within a series of video images of the video;
a component for tracking an object within the video, the tracking including identifying a fiducial region of the object within the series of video images, the fiducial region being one of: a point, a group of points, or a portion of an entire area of the object;
a component for monitoring the fiducial region for a restricted behavior with respect to the region of interest, wherein at least one of the fiducial region or the restricted behavior is specified by a user; and
a component for generating an alert in response to detecting the restricted behavior with respect to the region of interest.

9. The system of claim 8, wherein the fiducial region is one of: a centroid of a model for the object or a centroid of an area of the object visible within the video.

10. The system of claim 8, wherein the object is a person and wherein the fiducial region represents one of: a head, a hand, or a foot of the person.

11. The system of claim 8, wherein the region of interest comprises a linear trigger.

12. The system of claim 8, wherein the restricted behavior comprises a plurality of conditions for the object in the region of interest.

13. The system of claim 8, further comprising a component for monitoring at least one additional parameter with respect to the alert, wherein generating the alert requires detecting a specified condition of the at least one additional parameter.

14. A computer program comprising program code stored on a computer-readable medium, which when executed, enables a computer system to implement a method of detecting events in video, the method comprising:
monitoring a region of interest within a series of video images of the video;
tracking an object within the video, the tracking including identifying a fiducial region of the object within the series of video images, the fiducial region being one of: a point, a group of points, or a portion of an entire area of the object;
monitoring the fiducial region for a restricted behavior with respect to the region of interest, wherein at least one of the fiducial region or the restricted behavior is specified by a user; and
generating an alert in response to detecting the restricted behavior with respect to the region of interest.

15. The computer program of claim 14, wherein the fiducial region is one of: a centroid of a model for the object or a centroid of an area of the object visible within the video.

16. The computer program of claim 14, wherein the object is a person and wherein the fiducial region represents one of: a head, a hand, or a foot of the person.

17. The computer program of claim 14, wherein the region of interest comprises a linear trigger.

18. The computer program of claim 14, wherein the restricted behavior comprises a plurality of conditions for the object in the region of interest.

19. The computer program of claim 14, the method further comprising monitoring at least one additional parameter with respect to the alert, wherein generating the alert requires detecting a specified condition of the at least one additional parameter.

20. A method of generating a system for detecting events in video, the method comprising:
providing a computer system operable to:
monitor a region of interest within a series of video images of the video;
track an object within the video, the tracking including identifying a fiducial region of the object within the series of video images, the fiducial region being one of: a point, a group of points, or a portion of an entire area of the object;
monitor the fiducial region for a restricted behavior with respect to the region of interest, wherein at least one of the fiducial region or the restricted behavior is specified by a user; and
generate an alert in response to detecting the restricted behavior with respect to the region of interest.
